(19) United States
(12) Patent Application Publication
(10) Pub. No.: US 2026/0057361 A1
(43) Pub. Date: Feb. 26, 2026

(54) SETTLEMENT TERMINAL AND METHOD FOR SETTLEMENT TERMINAL

(71) Applicant: Toshiba Tec Kabushiki Kaisha, Tokyo (JP)

(72) Inventor: Kenya SUZUKI, Kamo Shizuoka (JP)

(21) Appl. No.: 19/202,553

(22) Filed: May 8, 2025

(30) Foreign Application Priority Data
Aug. 22, 2024 (JP) 2024-140565

(51) Int. Cl. G06Q 20/20; G06Q 20/34; G06V 10/82

(52) U.S. Cl. CPC G06Q 20/20; G06Q 20/352; G06V 10/82

(57) ABSTRACT

According to one embodiment, a settlement terminal includes a control unit which forecasts which one of the plurality of reading units will be used to perform settlement using a credit card, identifies which reading units are presently in a ready state, then cancels or turns off the ready state of the reading units other than the forecasted one. In general, the forecast may be provided by analysis of a picture of the customer at the settlement terminal holding the credit card prior to operation of the settlement terminal. The control unit may implement machine learning, such as a neural network for analysis of the picture and providing of the forecast.

### CROSS-REFERENCE TO RELATED APPLICATION

This application is based upon and claims the benefit of priority from Japanese Patent Application No. 2024-140565, filed Aug. 22, 2024, the entire contents of which are incorporated herein by reference.

### FIELD

Embodiments described herein relate generally to a settlement terminal incorporating multiple card reading unit types and a method for such terminals for avoiding unintended readings by reading units.

### BACKGROUND

A settlement terminal can be provided with a plurality of reading units for reading card media such as a credit card for making payments. Such a settlement terminal is known as a multi-settlement-type terminal. For example, a settlement terminal might be provided with a magnetic strip reader for a magnetic card and a noncontact near field communication (NFC) wireless reader for settlement via NFC-type cards/devices. An IC (chip) card reader may also be provided. Some customer cards may be provided with multiple reading options, such as an IC chip, a magnetic stripe, and a NFC function in some cases.

There is a problem with such multi-settlement-type terminals that when a customer performs settlement at a terminal provided with such a plurality of reading functions, with each reader in a ready state, there may be a reading with an unintended reading option in some cases. For example, when the customer moves a magnetic card closer to a magnetic reader slit provided in the settlement terminal to cause the card to be read, since the card also comes closer to the noncontact (NFC) reading region, the card may be unintentionally read in some cases by NFC before the magnetic reading is performed. When a reading function which is not intended by the customer operates in this way, it tends to generate confusion in the customer. Furthermore, in some examples, reward points associated with a completed transaction according to the purchase amount may depend on the reading function utilized for settlement even if the same card is used, thus it may be necessary to select the appropriate reading function.

### BRIEF DESCRIPTION OF THE DRAWINGS

FIG. 1 is a block diagram of a commodity sales data processing system according to an embodiment.

FIG. 2 depicts a settlement of commodity sales data processing system according to an embodiment.

FIG. 3 is a hardware block diagram of a settlement terminal.

FIG. 4 depicts a credit card viewed from an obverse surface.

FIG. 5 depicts a settlement terminal vertically installed.

FIG. 6 depicts a settlement terminal horizontally installed.

FIG. 7 depicts a data structure of a settlement terminal structure master.

FIG. 8 depicts aspects of an action forecasting model.

FIG. 9 is a functional block diagram of a settlement terminal according to an embodiment.

FIG. 10 is a flowchart of processing performed by a settlement terminal according to an embodiment.

### DETAILED DESCRIPTION

A problem for this disclosure to solve is to provide a settlement terminal that has multiple reading unit types that can avoid unintended readings by non-intended reading unit types. In some examples, a software program for such settlement terminals is provided.

In general, according to one embodiment, a settlement terminal includes a control unit. The control unit is configured to: forecast which one of a plurality of reading units will be used by an operator to read a card medium for transaction settlement; acquire information indicating which reading units of the plurality of reading units are in a ready state; and cancel the ready state of reading units other than the forecasted one of the plurality of reading units.

Certain example embodiments will hereinafter be described with reference to the drawings. It should be noted that this disclosure is not limited to these specific example embodiments described below.

A settlement terminal 30 for a commodity sales data processing system 10 as one embodiment of the present disclosure will be described.

### Schematic Configuration of Commodity Sales Data Processing System

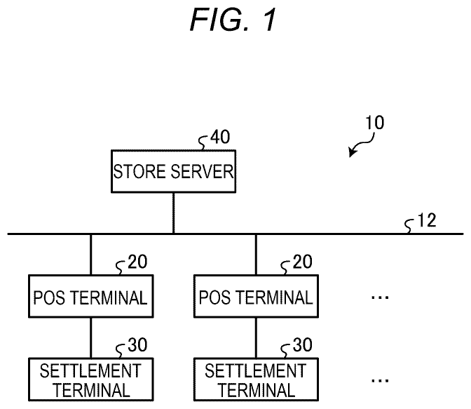

FIG. 1 is a block diagram showing an example of a schematic configuration of a commodity sales data processing system according to an embodiment.

The commodity sales data processing system 10 is a system which handles the commodity (merchandise) sales in a store and, for example, tracks the amount of commodities sold, sales totals, and the like. In this example, the processing system 10 is installed physically in the store, but is not limited thereto. The commodity sales data processing system 10 is provided with POS (Point of Sale) terminals 20, settlement terminals 30, and a store server 40. It should be noted that in general, a plurality of POS terminals 20 and a plurality of settlement terminals 30 are installed together to constitute a so-called full self-service commodity sales data processing system with which a customer can perform the checkout operations of item registration through transaction settlement by himself or herself. The store server 40 and the POS terminals 20 are connected with a network 12. The network 12 is, for example, a LAN (Local Area Network). It should be noted that the commodity sales data processing system 10 is not limited to the configuration in FIG. 1, and, in some examples, the POS terminal 20 may be a store clerk terminal device for a clerk to register commodities for purchase, and the settlement terminal 30 may be a terminal device with which the customer operates by himself or herself to perform the transaction settlement processing based on the commodity registration information from a POS terminal 20. In such a case, the settlement terminals 30 in FIG. 1 may be directly connected to the network 12, and the commodity sales data processing system 10 constitutes a so-called semi-self-service commodity sales data processing system.

However, in this example, POS terminal 20 is operated by the customer to thereby perform commodity registration processing for registering the item(s) to be bought by the customer.

The settlement terminal 30 is generally operated by the customer to perform cashless settlement processing for performing payment for the items on which the commodity registration processing was performed at a POS terminal 20. A cashless settlement is, for example, credit settlement using a credit card. The settlement terminal 30 may perform settlement processing other than credit settlement, such as electronic money settlement or code settlement.

The store server 40 acquires and then stores a history file (or a transaction file) of the commodity registration processing performed at the POS terminal 20 and a history file (or a transaction file) of the cashless settlement processing performed at the settlement terminal 30. Furthermore, the store server 40 monitors whether the POS terminals 20 and the settlement terminals 30 operate normally.

### Schematic Configuration of Settlement Terminal

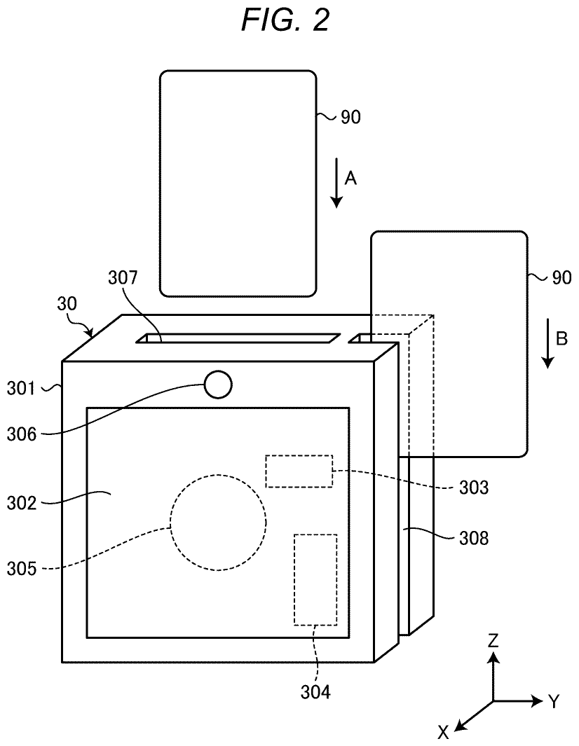

A schematic configuration of the settlement terminal 30 will be described using FIG. 2. FIG. 2 is a perspective view showing an example of a settlement terminal 30 provided in the commodity sales data processing system according to an embodiment.

The settlement terminal 30 is formed of a housing 301 shaped like a rectangular parallelepiped and is provided with a display panel 302 on a front surface of the housing 301 (at an X-axis positive side in FIG. 2). Information related to an operation state and so on of the settlement terminal 30 is displayed on the display panel 302. The display panel 302 is, for example, a liquid crystal monitor or an organic electroluminescence (EL) monitor. It should be noted that the display panel 302 may also incorporate a function of an operation (user input) panel which receives an input operation from the customer on a variety of operation buttons displayed on the display panel 302. The function of an operation panel can be realized by a touch panel being stacked on or otherwise integrated with the display panel 302.

The settlement terminal 30 is provided with a plurality of reading units for reading information registered in a credit card 90 belonging to the customer.

The settlement terminal 30 shown in FIG. 2 is provided with an IC card reader 303, a magnetic card reader 304, and an antenna 305 as reading units.

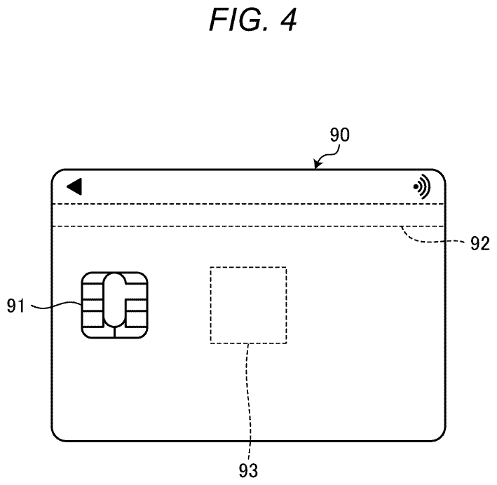

The IC card reader 303 contacts an IC chip 91 (see FIG. 4) in the credit card 90 to read the information registered in the IC chip 91. Specifically, the IC card reader 303 makes contact with the IC chip 91 of a credit card 90 which is inserted via an IC card insertion slot 307 in the direction of arrow A to read the information registered in the IC chip 91. The IC card reader 303 is an example of a contact IC card reading unit in the present disclosure.

For the settlement terminal 30 in FIG. 2, the IC card insertion slot 307 is formed on an upper end of the housing 301. However, the position at which the IC card insertion slot 307 is formed is not limited.

The magnetic card reader 304 contacts a magnetic stripe 92 (see FIG. 4) of the credit card 90 to read information registered in the magnetic stripe 92. Specifically, the magnetic card reader 304 reads the information registered in the magnetic stripe 92 of the credit card 90 inserted into a scanning groove 308, and then scanned (moved) along the direction of arrow B. The magnetic card reader 304 is an example of a magnetic card reading unit in the present disclosure.

For the settlement terminal 30 in FIG. 2, the scanning groove 308 is formed on a right side of the housing 301. However, the position at which the scanning groove 308 is formed is not limited.

The antenna 305 performs the near field wireless communication (e.g., NFC (Near Field Communication)) with a noncontact IC chip 93 (see FIG. 4) in the credit card 90 to read the information registered in the noncontact IC chip 93. Specifically, the antenna 305 performs the near field wireless communication with the noncontact IC chip 93 which is brought close to the display panel 302 to read the noncontact IC chip 93. The antenna 305 is an example of a noncontact IC card reading unit in the present disclosure.

The settlement terminal 30 is further provided with a camera 306. The camera 306 is installed in the settlement terminal 30 to be able to take a picture of an upper body and face of the customer who is operating the settlement terminal 30. The camera 306 is an example of an imaging unit in the present disclosure. It should be noted that the camera 306 is not necessarily required to be incorporated directly in the settlement terminal 30 in all embodiments. For example, the camera 306 may be installed on a ceiling to take a picture of the customer who is operating the settlement terminal 30.

It should be noted that although not specifically shown in FIG. 2, the settlement terminal 30 may further be provided with a numerical keypad for inputting a personal identification number or the like.

### Hardware Configuration of Settlement Terminal

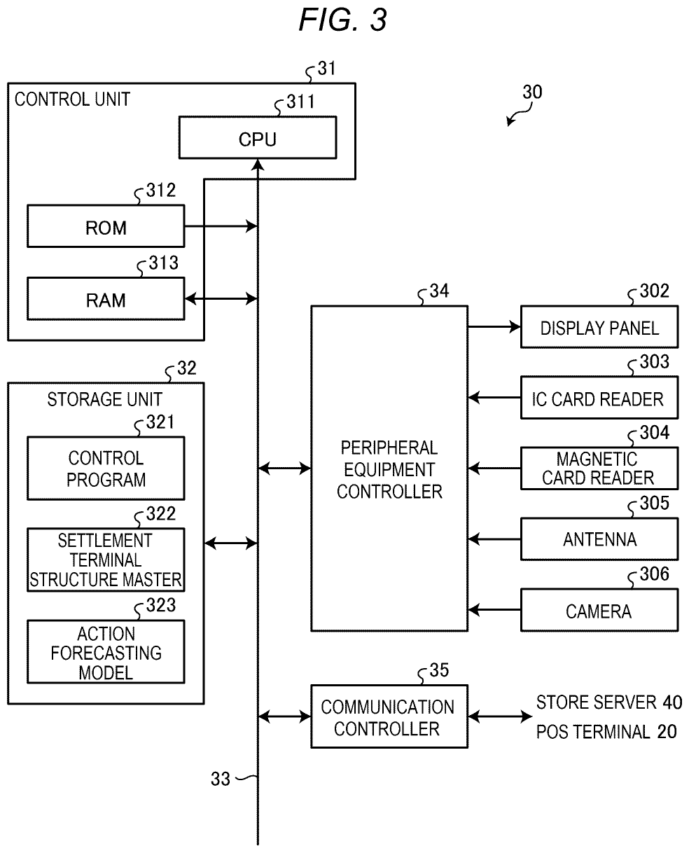

A hardware configuration of the settlement terminal 30 will be described using FIG. 3.

The settlement terminal 30 has a control unit 31, a storage unit 32, a peripheral equipment controller 34, and a communication controller 35 that are coupled to each other with an internal bus 33.

The control unit 31 controls an overall operation of the settlement terminal 30. The control unit 31 is provided with a CPU (Central Processing Unit) 311, a ROM (Read Only Memory) 312, and a RAM (Random Access Memory) 313. The CPU 311 is coupled to the ROM 312 and the RAM 313 via internal buses such as an address bus and a data bus. The CPU 311 executes a variety of programs stored in the ROM 312 or the storage unit 32. The CPU 311 operates with the variety of programs loaded in the RAM 313 to control the settlement terminal 30.

The storage unit 32 is a storage device such as an HDD (Hard Disk Drive) or an SSD (Solid State Drive). Further, the storage unit 32 may be a nonvolatile memory such as a flash memory in which information is held even after turning off the power. The storage unit 32 stores a control program 321, a settlement terminal structure master 322, and an action forecasting model 323.

The control program 321 is a software algorithm for controlling an overall operation of the settlement terminal 30. The control program 321 may be provided by being stored in the storage unit 32 or by being recorded on a computer-readable, non-transitory recording medium such as a CD-ROM, a flexible disk (FD), a CD-R, or a DVD as a file in a installable format or an executable format. Further, the control program 321 may be stored on a computer connected to a network and provided by being downloaded via the network. Further, the control program 321 may be accessed or distributed via a network such as the Internet.

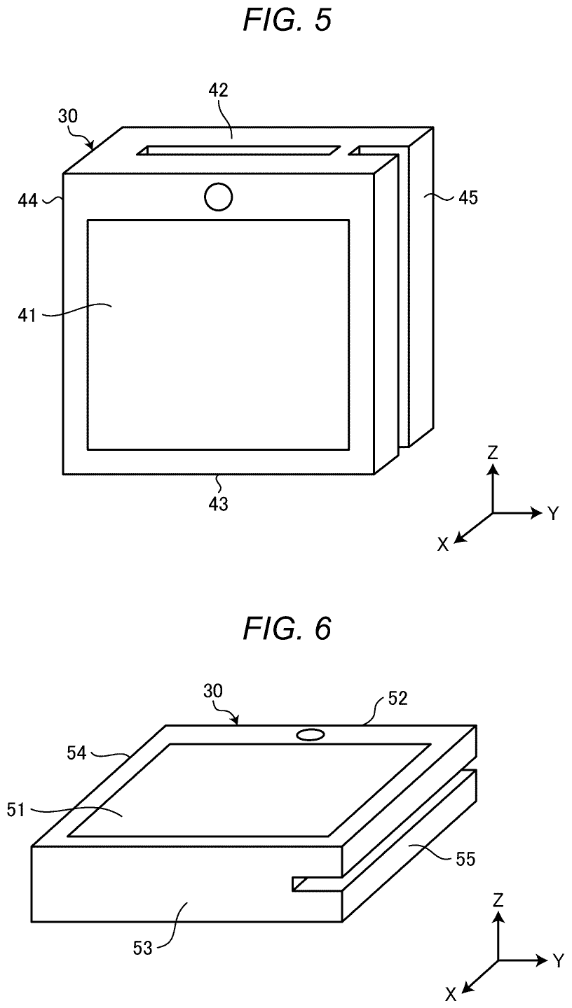

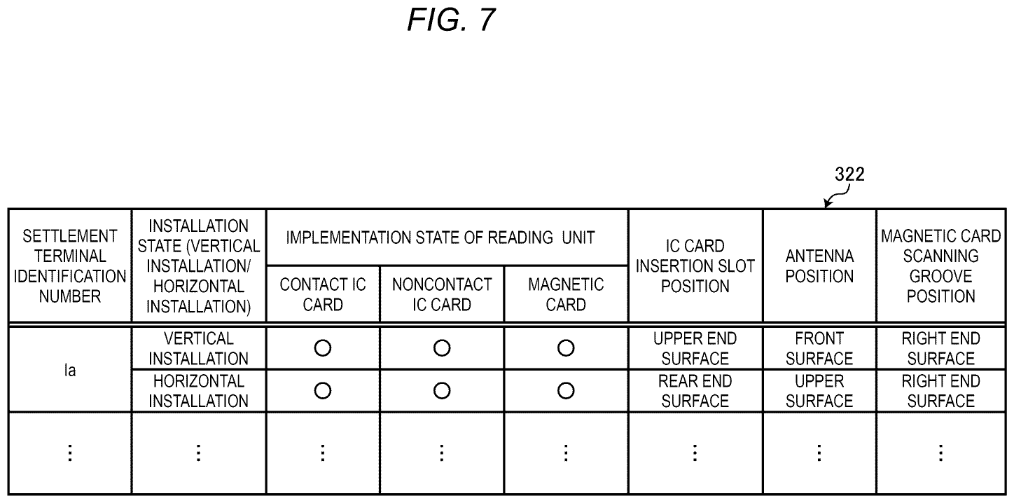

The settlement terminal structure master 322 is a master file which stores indications of the installation state of the settlement terminal 30, the implementation state of the reading units, and the installation positions of a variety of accessory devices related to the reading units in association with an identification number for uniquely identifying the settlement terminal 30 of concern. In this context, the installation state of the settlement terminal 30 indicates the installed orientation of the settlement terminal 30, such as whether the settlement terminal 30 is installed in an upright (vertical) orientation state or a planar (horizontal) state (see FIG. 5 and FIG. 6). Information related to the installation positions of the variety of accessory devices related to the reading units is in a master file which stores, for example, an installation position of the IC card insertion slot 307 for the IC card reader 303 when present, an installation position of the antenna 305 when present, and an installation position of the scanning groove 308 for the magnetic card reader 304 when present. An example structure of a settlement terminal structure master 322 is depicted in FIG. 7.

In some examples, the settlement terminal structure master 322 may be stored in the store server 40. In such a case, the settlement terminal 30 may store only its own identification number and then read or receive information corresponding to its own identification number from the settlement terminal structure master 322 from the store server 40 on an as needed basis.

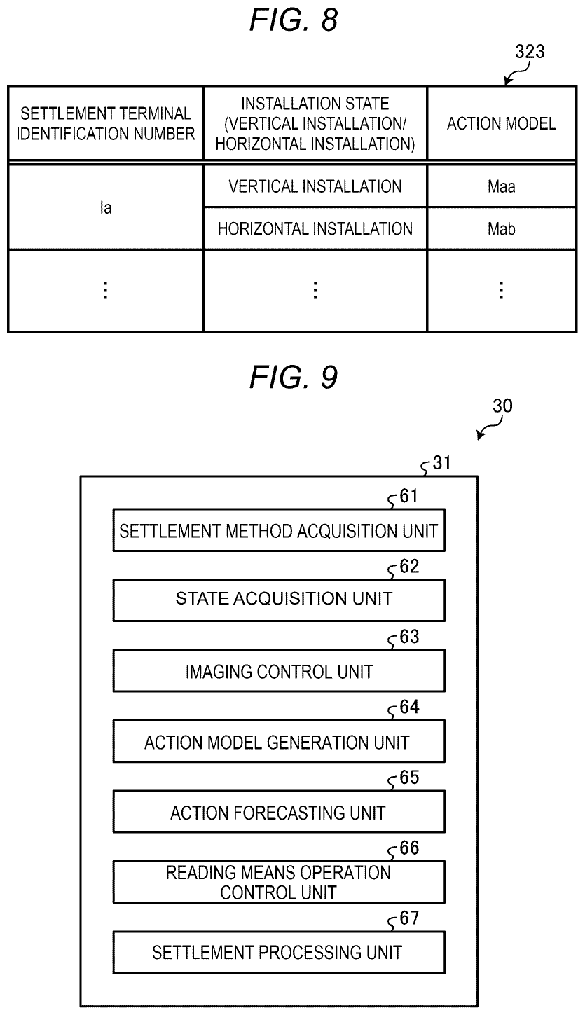

The action forecasting model 323 concerns the expected or typical actions of customers when performing settlement at the settlement terminal 30. The action forecasting model 323 provides an action forecasting model in association with the identification number of the settlement terminal 30 and the installation state of the settlement terminal 30. An example structure of the action forecasting model 323 is described in conjunction with FIG. 8.

In some examples, the action forecasting model 323 may be stored in the store server 40, and the settlement terminal 30 may store only its own identification number and its own installation state. In such cases, the settlement terminal 30 may then read an action forecasting model 323 corresponding to its identification number and installation state from the store server 40 on an as needed basis.

The control unit 31 is coupled to the display panel 302, the IC card reader 303, the magnetic card reader 304, the antenna 305, and the camera 306 via the peripheral equipment controller 34. That is, the control unit 31 can be coupled to a variety of input-output devices via the peripheral equipment controller 34. Such input-output devices are not limited to those above.

Further, the control unit 31 sends and receives a variety of types of information to and from the store server 40 and the POS terminal 20 via the communication controller 35.

For example, the control unit 31 outputs a result of the settlement processing to the store server 40 via the communication controller 35.

Further, the control unit 31 acquires the commodity registration information from the POS terminal 20 via the communication controller 35.

### Schematic Configuration of Credit Card

A schematic configuration of the credit card 90 will be described using FIG. 4. FIG. 4 depicts a typical credit card as viewed from an obverse (front) surface.

The credit card 90 is a payment card which belongs to the customer. A variety of information related to payment processing (a name of the customer, a card number, a debit account number of the settlement amount, etc.) is registered in/on the credit card 90. The credit card 90 is one example of a card medium in the present disclosure.

The IC chip 91 is embedded in the credit card 90 with portions thereof visible on the obverse side (see FIG. 4). Electrodes of the IC chip 91 are exposed at the surface on the obverse side, and when the credit card 90 is inserted (correctly) into the IC card insertion slot 307 (see FIG. 2), the electrodes of the IC chip 91 make contact with the IC card reader 303 (see FIG. 2) to read information related to the settlement from the IC chip 91. The credit card provided with such an IC chip 91 is called a contact IC card in some cases.

On a reverse surface of the credit card 90, the magnetic stripe 92 is disposed. By scanning the magnetic stripe 92 along the scanning groove 308 (see FIG. 2), the magnetic card reader 304 (see FIG. 2) reads information related to the settlement from the magnetic stripe 92. The credit card provided with such a magnetic stripe 92 is called a magnetic card in some cases.

A noncontact IC chip 93 can be embedded inside the credit card 90. The antenna 305 (see FIG. 2) of the settlement terminal 30 reads information related to settlement from the noncontact IC chip 93 upon coming close to the noncontact IC chip 93. The credit card provided with such a noncontact IC chip 93 is called a noncontact IC card in some cases. It should be noted that a configuration in which the IC chip 91 described above also functions as the noncontact IC chip 93 may be adopted.

### Arrangement State of Settlement Terminal

Arrangement states the settlement terminal 30 will be described using FIG. 5 and FIG. 6. FIG. 5 is a diagram showing an example of the settlement terminal 30 vertically installed. FIG. 6 is a diagram showing the settlement terminal 30 horizontally installed.

The same settlement terminal 30 described in FIG. 2 can be either vertically installed, as shown in FIG. 5, or horizontally installed, as shown in FIG. 6.

When the settlement terminal 30 is vertically installed as in FIG. 5, the IC card insertion slot 307 (see FIG. 2) can be on any one of the upper end surface 42, the lower end surface 43, the left end surface 44, or the right end surface 45. The scanning groove 308 (see FIG. 2) can be provided on any one of the upper end surface 42, the lower end surface 43, the left end surface 44, or the right end surface 45 5. The antenna 305 (see FIG. 2) is installed at behind the front surface 41 depicted in FIG. 5.

On the other hand, when the settlement terminal 30 is horizontally installed as in FIG. 6, the IC card insertion slot 307 (see FIG. 2) can be provided on any one of the rear end surface 52, the front end surface 53, the left end surface 54, or the right end surface 55 shown in FIG. 6. The scanning groove 308 (see FIG. 2) can be provided on any one of the rear end surface 52, the front end surface 53, the left end surface 54, or the right end surface 55 shown in FIG. 6. The antenna 305 (see FIG. 2) can be installed below the upper surface 51 depicted in FIG. 6.

Whether the settlement terminal 30 is vertically installed or horizontally installed, and on which surfaces the IC card insertion slot 307 and the scanning groove 308 are provided is registered in the settlement terminal structure master 322 (see FIG. 3) in association with the identification number for the settlement terminal 30.

### Data Structure of Settlement Terminal Structure Master

FIG. 7 depicts an example of the data structure of the settlement terminal structure master 322.

The settlement terminal structure master 322 stores the installation state (e.g., vertical or horizontal) of each settlement terminal 30 (by unique identification number) along with the implementation state (e.g., included or not in the settlement terminal 30) of the various possible reading unit types and the installation positions the related reading unit structures such as the installation position of the IC card insertion slot 307, the installation position of the antenna 305, and the installation position of the scanning groove 308.

In the present context, the installation state entry for the settlement terminal 30 is information indicating whether the settlement terminal 30 is vertically installed (as shown in FIG. 5) or horizontally installed (as shown in FIG. 6).

In the present context, the implementation state entries are information indicating whether an IC card reader 303, an antenna 305, and an magnetic card reader 304 are included in the settlement terminal 30.

FIG. 7 shows that the settlement terminal 30 with the settlement terminal identification number of Ia has an IC card reader 303, an antenna 305, and a magnetic card reader 304.

The installation position entry for the IC card insertion slot 307 is information representing on which surface of the settlement terminal 30 the IC card insertion slot 307 is formed when the settlement terminal 30 has an IC card reader 303.

FIG. 7 shows that when the settlement terminal 30 with the settlement terminal identification number of Ia is vertically installed, the IC card insertion slot 307 is formed on the upper end surface 42. It is similarly shown that when the settlement terminal 30 with the settlement terminal identification number of Ia is horizontally installed, the IC card insertion slot 307 is formed on the rear end surface 52.

The installation position entry for the antenna 305 is information representing on which surface of the settlement terminal 30 the antenna 305 is formed when the settlement terminal 30 is provided with the antenna 305.

FIG. 7 shows that when the settlement terminal 30 with settlement terminal identification number of Ia is vertically installed, the antenna 305 is embedded in the front surface 41. Similarly, it is shown that when the settlement terminal 30 with settlement terminal identification number of Ia is horizontally installed, the antenna 305 is embedded in the upper surface 51.

The installation position of the scanning groove 308 is information representing on which surface of the settlement terminal 30 the scanning groove 308 is formed when the settlement terminal 30 has a magnetic card reader 304.

FIG. 7 shows that when the settlement terminal 30 with the settlement terminal identification number of Ia is vertically installed, the scanning groove 308 is formed on the right end surface 45. Similarly, it is shown that when the settlement terminal 30 with the settlement terminal identification number of Ia is horizontally installed, the scanning groove 308 is formed on the right end surface 45.

In this way, when the identification number and the installation state (vertical installation or horizontal installation) of the settlement terminal 30 are known, the included types of the reading units and the corresponding installation positions of the IC card insertion slot 307, the antenna 305, and the scanning groove 308, if any, can be identified by referring to the settlement terminal structure master 322.

### Data Structure of Action Forecasting Model

A data structure of the action forecasting model 323 will be described using FIG. 8.

The action forecasting model 323 stores action models Maa, Mab in association with the identification number for uniquely identifying the settlement terminal 30 and its installation state (e.g., the vertical installation or the horizontal installation).

The action models Maa, Mab are machine learning models which have been trained to learn the relationships between actions of the customer using the credit card 90 at the settlement terminal 30 and the reading unit used at settlement terminal 30. The action models Maa, Mab are, for example, a neural network. The input to the action models Maa, Mab can be a picture obtained by imaging the actions of the customer holding the credit card 90, and the outputs from the action models Maa, Mab are a prediction of the particular reading unit at the settlement terminal 30 that the customer will use based on the input.

The action model Maa is a recognition model that may be generated by setting up a settlement terminal 30, the identification number of which is known, in the vertical orientation and having a number of users use a credit card 90 at the settlement terminal 30. More specifically, the action model Maa is a model which has learned a relationship between early actions of users with the credit card 90 (e.g., a manner of gripping or holding the credit card 90 or hand/card placement or movements) and the particular reading unit which is ultimately used at the settlement terminal 30. Images of the user operating the settlement terminal 30 may be acquired by camera 306.

The action model Mab is a recognition model that may be generated by setting up a settlement terminal 30, the identification number of which is known, in the horizontal orientation and having a number of users use a credit card 90 at the settlement terminal 30. More specifically, the action model Mab is a model which has learned a relationship between early actions of users with the credit card 90 (e.g., a manner of gripping or holding the credit card 90 or hand/card placement or movements) and the particular reading unit which is ultimately used at the settlement terminal 30. Images of the user operating the settlement terminal 30 may be acquired by camera 306.

The commodity sales data processing system 10 can generate, in advance, the action forecasting model 323 for each installation state of a settlement terminal 30 by performing substantially the same learning with respect to a plurality of settlement terminals 30 having different in installation positions for the reading units (the position of the IC card insertion slot 307, the position of the antenna 305, and the position of the scanning groove 308).

The action models Maa, Mab can be generated by, for example, deep learning. The action models Maa, Mab are obtained by describing the relationship(s) between the actions of the user, changes in orientation of the credit card 90 held by the user, and other information that may be extracted from a picture (or pictures) obtained by recording the user operating by the settlement terminal 30 and the particular reading unit ultimately used by the user at the settlement terminal 30. For example, action models Maa, Mab can be a multilayer neural network.

The settlement terminal 30 is thus able to forecast which reading unit the customer will use to read the credit card 90 by using the action models Maa, Mab corresponding to the settlement terminal 30 and its orientation by analyzing the actions of the customer in images from the camera 306.

### Functional Configuration of Settlement Terminal

A functional configuration of the settlement terminal 30 will be described using FIG. 9. FIG. 9 is a functional block diagram showing an example of the functional configuration of the settlement terminal according to the embodiment.

The control unit 31 of the settlement terminal 30 realizes a settlement method acquisition unit 61, a state acquisition unit 62, an imaging control unit 63, an action model generation unit 64, an action forecasting unit 65, a reading-unit operation control unit 66, and a settlement processing unit 67 as functional units by developing the control program 321 in the RAM 313 and then operating the control program 321. It should be noted that all or some of these functional units may be realized by dedicated hardware.

The settlement method acquisition unit 61 acquires the settlement method selected by an operation of the customer. Specifically, the settlement method acquisition unit 61 acquires the settlement method selected by the customer from, for example, a plurality of alternatives of the settlement method displayed on the display panel 302.

The state acquisition unit 62 acquires information indicating which reading units in the settlement terminal 30 are set in a ready state. Specifically, the state acquisition unit 62 checks whether the reading unit corresponding the settlement method acquired by the settlement method acquisition unit 61 is in the ready state by referring to a settings table or the like. It should be noted that the state acquisition unit 62 is an example of a ready state acquisition unit in the present disclosure.

The imaging control unit 63 makes the camera 306 record a picture of the customer who is using the settlement terminal 30.

The action model generation unit 64 generates the action models Maa, Mab by making the settlement terminal 30, the identification number of which is known, read the credit card 90 with the reading unit provided with an instruction in a state in which a plurality of panelists is made to grip the credit card 90.

The action forecasting unit 65 forecasts which one of the plurality of reading units is going to be used to read the credit card 90 at the settlement terminal 30.

When multiple reading units are in the ready state, the reading-unit operation control unit 66 places the reading units other than the reading unit forecasted by the action forecasting unit 65 in an non-ready state.

The settlement processing unit 67 executes the settlement processing using the settlement method thus designated.

### Flow of Processing Performed by Settlement Terminal

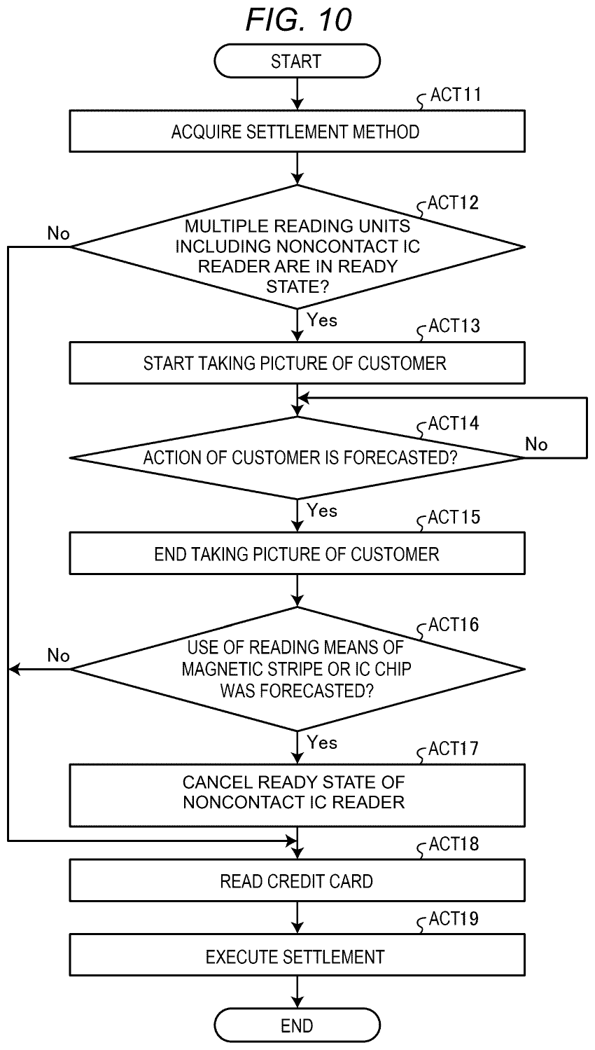

A flow of the processing performed by the settlement terminal 30 will be described using FIG. 10. FIG. 10 is a flowchart showing an example of the flow of the processing performed by the settlement terminal according to the embodiment. It should be noted that it is assumed that the settlement terminal 30 already stored the action forecasting model 323 including the action models Maa, Mab generated by the action model generation unit 64.

The settlement method acquisition unit 61 acquires (ACT11) the settlement method selected by an operation of the customer.

The state acquisition unit 62 determines (ACT12) whether the settlement terminal 30 has multiple reading units (including particularly the reading unit of the noncontact IC chip 93) in a ready state (state in which reading is possible). If so (Yes in ACT12), the process proceeds to ACT13. On the other hand, if not (No in ACT12), the process proceeds to ACT18.

In ACT13 the imaging control unit 63 makes the camera 306 start (ACT13) recording of the picture of the customer who is using the settlement terminal 30.

The action forecasting unit 65 determines (ACT14) whether the action of the customer is forecasted. When it is determined that the action of the customer is forecasted (Yes in ACT14), the process proceeds to ACT15. On the other hand, when it is not determined that the action of the customer is forecasted (No in ACT14), ACT14 is repeated.

When it is determined in ACT14 that the action of the customer is forecasted, the imaging control unit 63 ends (ACT15) recording of the picture of the customer.

The action forecasting unit 65 determines (ACT16) whether it is forecasted that the customer uses the reading unit of the magnetic stripe 92 or the IC chip 91. When it is determined that it is forecasted that the customer uses the reading unit of the magnetic stripe 92 or the IC chip 91 (Yes in ACT16), the process proceeds to ACT17. On the other hand, when it is not determined that it is forecasted that the customer uses the reading unit of the magnetic stripe 92 or the IC chip 91 (No in ACT16), the process proceeds to ACT18.

When it is determined in ACT16 that it is forecasted that the customer uses the reading unit of the magnetic stripe 92 or the IC chip 91, the reading-unit operation control unit 66 cancels (ACT17) the ready state of the reading unit of the noncontact IC chip 93.

The settlement processing unit 67 reads (ACT18) the information registered in the credit card 90.

The settlement processing unit 67 performs (ACT19) the settlement processing using the method thus designated. Subsequently, the settlement terminal 30 ends the processing.

### Functions and Advantages of Embodiment

As described hereinabove, the settlement terminal 30 (an information reading apparatus) is provided with the action forecasting unit 65 is going to be used to perform reading of the credit card 90 (a card medium) belonging to the customer (an operator), the state acquisition unit 62 (a standby state acquisition unit) which acquires the information indicating which reading unit(s) the settlement terminal 30 sets to the standby state in which the reading unit can operate, and the reading-unit operation control unit 66 cancels the standby state of the reading units other than the reading unit forecasted by the action forecasting unit 65. Therefore, it is possible for the settlement terminal 30 to read the information of the credit card 90 using the reading unit intended by the operator. More specifically, when the action forecasting unit 65 forecasts that the customer is going to make a reading unit other than the noncontact reading unit read the information of the credit card 90, the reading-unit operation control unit 66 cancels the standby state of the noncontact reading unit, and therefore, it is possible for the settlement terminal 30 to read the information of the credit card 90 with the reading unit intended by the customer. Thus, it is possible to prevent harmful effects such as a failure to provide reward points associated with reading the credit card 90 with a particular reading unit.

The settlement terminal 30 (the information reading apparatus) is further provided with the IC card reader 303 (the contact IC card reading unit) which reads the information registered in the IC chip 91 inserted by the customer (operator) into the IC card insertion slot 307 of the settlement terminal 30, and the magnetic card reader 304 (the magnetic card reading unit) which reads the information registered in the magnetic stripe 92 scanned (passed) through the scanning groove 308 of the settlement terminal 30. Therefore, it is possible to read the information of the credit card 90 with a reading unit intended by the customer even in the multi-settlement terminal provided with a plurality of reading units.

Further, in the settlement terminal 30 (the information reading apparatus) in the embodiment, the action forecasting unit 65 analyzes a picture taken by the camera 306 (an imaging unit) for taking a picture of the customer (the operator) to thereby forecast which one of the reading unit the customer is going to use to read the credit card 90 (the card medium). Therefore, it is possible to easily and reliably forecast the reading unit which the customer is going to use.

Further, in the settlement terminal 30 (the information reading apparatus) in the embodiment, the action forecasting unit 65 forecasts which one of the reading unit the customer is going to use to read the credit card 90 (the card medium) based on the action models Maa, Mab generated by learning the picture of the customer (the operator) who is operating the settlement terminal 30. Therefore, it is possible to easily and reliably forecast the reading unit which the customer is going to use. Further, since the action models Maa, Mab are generated by learning, the accuracy of the forecast can be improved by advancing the learning.

Further, in the settlement terminal 30 (the information reading apparatus) in the embodiment, the action models Maa, Mab are generated in association with reading unit implementation information representing which of the plurality of reading units are implemented in the settlement terminal 30 operated by the customer (the operator), the installation position of the IC card insertion slot 307 in the settlement terminal 30, installation position of the scanning groove 308, and the installation position of the antenna 305 as a receiving unit of the noncontact reading unit. Therefore, it is possible to forecast the action of the customer based on the appropriate action models Maa, Mab independent of the installation state of the settlement terminal 30 and the structure of the settlement terminal 30.

While certain embodiments of this disclosure are hereinabove described, these embodiments are illustrative only, and it is not intended to limit the scope of this disclosure. These novel embodiments can be implemented in a variety of other forms, and various omissions, substitutions, and changes may be made without departing from the spirit of this disclosure. These embodiments and the modifications thereof are included in the scope and spirit of this disclosure, and at the same time, are included as set forth in the appended claims and their equivalents.

What is claimed is:

1. A settlement terminal, comprising:
a control unit configured to:
forecast which one of a plurality of reading units will be used by an operator to read a card medium for transaction settlement;
acquire information indicating which reading units of the plurality of reading units are in a ready state; and
cancel the ready state of reading units other than the forecasted one of the plurality of reading units.

2. The settlement terminal according to claim 1, wherein the plurality of reading units includes:
a non-contact IC card reading unit configured to read information registered in a non-contact IC chip via an antenna,
a contact IC card reading unit configured to read information registered in a contact IC chip inserted into an IC card insertion slot, and
a magnetic card reading unit configured to read information registered in a magnetic stripe scanned through a scanning groove.

3. The settlement terminal according to claim 1, wherein the control unit forecasts which one of the plurality of reading units will be used by analyzing a picture taken by an imaging unit configured to take pictures of the operator.

4. The settlement terminal according to claim 3, wherein the control unit analyzes the picture using a machine learning model.

5. The settlement terminal according to claim 4, wherein the machine learning model is associated with an installation orientation of the settlement terminal.

6. The settlement terminal according to claim 4, wherein the machine learning model is a neural network.

7. The settlement terminal according to claim 3, further comprising:
the imaging unit.

8. The settlement terminal according to claim 1, further comprising:
an antenna;
a IC card insertion slot; and
a magnetic card scanning groove.

9. The settlement terminal according to claim 8, wherein the plurality of reading units includes:
a non-contact IC card reading unit configured to read information registered in a non-contact IC chip via the antenna;
a contact IC card reading unit configured to read information registered in an IC chip inserted into the IC card insertion slot; and
a magnetic card reading unit configured to read information registered in a magnetic stripe scanned through the magnetic card scanning groove.

10. The settlement terminal according to claim 9, further comprising:
a camera positioned to image the operator using the settlement terminal.

11. The settlement terminal according to claim 10, wherein the control unit forecasts which one of the plurality of reading units will be used by analyzing a picture taken by the camera.

12. The settlement terminal according to claim 11, wherein the control unit analyzes the picture using a machine learning model associated with an installation orientation of the settlement terminal.

13. The settlement terminal according to claim 12, wherein the machine learning model is a neural network.

14. A settlement terminal, comprising:
a camera positioned to acquire images of operators holding credit cards at the settlement terminal;
an antenna;
an IC card insertion slot;
a magnetic card scanning slot;
a plurality of reading units including:
a non-contact IC card reading unit configured to read information from a non-contact IC chip of a credit card via the antenna,
a contact IC card reading unit configured to read information from a contact IC chip of a credit card inserted into the IC card insertion slot, and
a magnetic card reading unit configured to read information from a magnetic stripe scanned through the magnetic card scanning groove; and
a control unit configured to:
based on an image from the camera, forecast which one of the plurality of reading units will be used by an operator for transaction settlement;
acquire information indicating which reading units of the plurality of reading units are in a ready state; and
cancel the ready state of the reading units other than the forecasted one of the plurality of reading units.

15. The settlement terminal according to claim 14, wherein the control unit forecasts which one of the plurality of reading units will be used by analyzing the picture using a machine learning model associated with an installation orientation of the settlement terminal.

16. The settlement terminal according to claim 15, wherein the machine learning model is a neural network.

17. A non-transitory, computer-readable medium storing program instructions which when executed by a control unit of a settlement terminal causes the settlement to perform a method comprising:
forecasting which one of a plurality of reading units will be used by an operator to read a card medium for transaction settlement;
acquiring information indicating which reading units of the plurality of reading units are in a ready state; and
cancelling the ready state of reading units other than the forecasted one of the plurality of reading units.

18. The non-transitory, computer-readable medium according to claim 17, wherein the forecasting of which one of the plurality of reading units will be used is provided by analyzing a picture taken by an imaging unit configured to take pictures of the operator at the settlement terminal.

19. The non-transitory, computer-readable medium according to claim 18, wherein the control unit analyzes the picture using a machine learning model.

20. The non-transitory, computer-readable medium according to claim 17, wherein the plurality of reading units includes:
a non-contact IC card reading unit configured to read information registered in a non-contact IC chip via an antenna,
a contact IC card reading unit configured to read information registered in a contact IC chip inserted into an IC card insertion slot, and
a magnetic card reading unit configured to read information registered in a magnetic stripe scanned through a scanning groove.
